(19) United States
(12) Patent Application Publication
(10) Pub. No.: US 2025/0018338 A1
(43) Pub. Date: Jan. 16, 2025

(54) Carbon Dioxide Capture Method for Coupled Staged Electrolysis/Pyrolysis Hydrogen Production

(71) Applicant: STATE POWER INVESTMENT CORPORATION RESEARCH INSTITUTE, Beijing (CN)

(72) Inventors: Xijia LV, Beijing (CN); Hao ZHANG, Beijing (CN); Tu ZHAO, Beijing (CN)

(21) Appl. No.: 18/711,449

(22) PCT Filed: Nov. 26, 2021
(86) PCT No.: PCT/CN2021/133635

§ 371 Date: Jun. 19, 2024

(30) Foreign Application Priority Data
Nov. 17, 2021 (CN) 202111365070.3

(51) Int. Cl. B01D 53/96; B01D 53/14; B01D 53/62; B01D 53/75; B01D 53/78; C25B 1/02

(52) U.S. Cl. CPC B01D 53/965; B01D 53/1406; B01D 53/1418; B01D 53/1425; B01D 53/1475; B01D 53/1493; B01D 53/62; B01D 53/75; B01D 53/78; B01D 2251/304; B01D 2251/604; B01D 2257/504; C25B 1/02

(57) ABSTRACT

The present disclosure provides a carbon dioxide capture method for coupled staged electrolysis/pyrolysis hydrogen production. The method includes: capturing CO₂ in a target component by using an alkaline solution and obtaining a carbonate solution; enabling the carbonate solution to be subjected to mild electrolysis, obtaining a hydroxide and H₂ at a cathode, obtaining bicarbonate and a mixed gas of O₂/CO₂ mixed gas at an anode, and absorbing the CO₂ from the mixed gas through a small absorption tower to obtain pure oxygen; recycling the hydroxide to serve as a capture agent; and pyrolyzing the bicarbonate to obtain pure CO₂. According to the method for cyclically absorbing/releasing the CO₂ by using the alkaline solution, a technology for capturing CO₂ within a wide concentration range may be provided.

### CROSS-REFERENCE TO RELATED APPLICATION

The present application is a National Stage of International Patent Application No. PCT/CN2021/133635 filed on Nov. 26, 2021 which claims the benefit of priority to the Chinese Patent Application No. 202111365070.3 filed on Nov. 17, 2021, which is herein incorporated by reference in their entirety.

### TECHNICAL FIELD

The present disclosure relates to the field of carbon capture, utilization and storage, in particular, to a carbon dioxide capture method for coupled staged electrolysis/pyrolysis hydrogen production.

### BACKGROUND

China has set objectives to achieve “carbon peak” and “carbon neutrality” by 2030 and 2060, respectively. However, annual carbon emissions of China exceed 2.7 billion tons at present, and a global annual carbon capture amount is only about 40 million tons. There is still a long way to go to achieve the objectives of “carbon peak” and “carbon neutrality”. Therefore, it is of great significance to accelerate research and development of a low-cost and efficient carbon capture technology.

At present, domestic and international mainstream CO₂ capture methods mainly include a liquid amine adsorption method, a solid-state membrane adsorption method, and the like, all of which have been subjected to pilot demonstrations. But when the above methods are used for carbon capture, only high-concentration CO₂ can be captured, and CO₂ within a wide concentration range cannot be captured, for example, low-concentration CO₂ in air cannot be captured. However, in reality, a total amount of CO₂ in various concentration ranges is enormous. If the CO₂ within the wide concentration range can be captured, an immeasurable promotion effect will be achieved to achieve the objectives of carbon neutrality and greenhouse effect control. In addition, when absorbents such as liquid amine is regenerated, a large amount of steam needs to be consumed, and problems of large energy consumption, increases of fuel consumption and carbon dioxide emissions, and the like will be brought. A technology for capturing the CO₂ in air developed in recent years can not only capture the high-concentration CO₂, but also capture the low-concentration CO₂. A method for adsorbing the CO₂ by using an alkaline solution and a solid-state amine membrane is mainly adopted, which can capture the CO₂ within the wide concentration range and has potential to significantly increase CO₂ capture application scenarios and improve a CO₂ capture amount. Therefore, the method has received wide attention and high attention domestically and internationally, which is gradually becoming an international cutting-edge hotspot in a CO₂ capture field.

In the above technology for capturing CO₂ in air, a bottleneck that it is difficult to regenerate CO₂ adsorbents at a present stage limits further development of the technology for capturing the CO₂ in the air. When the CO₂ in the air is captured by taking the solid-state amine membrane as an adsorbent, reduction and regeneration of an amine adsorbent also consume a large amount of steam, which cannot avoid the problems of high energy consumption and increase of CO₂ emissions. There are often two methods for regenerating the alkaline solution when low-concentration CO₂ is captured by taking the alkaline solution as the adsorbent. One is to regenerate the alkaline solution through two chemical cycles of regeneration, that is, carbonate after absorbing the CO₂ reacts with Ca(OH)₂ to regenerate the alkaline solution, and CaCO₃ is obtained at the same time; and the obtained CaCO₃ is calcined to obtain CaO, and the CaO reacts with H₂O to regenerate the Ca(OH)₂. This method involves two chemical cycles, a system is complex, calcination energy consumption is high, and the CaO is easy to inactivate, which not only significantly increases additional energy consumption and the CO₂ emissions, but also leads to a sharp increase in investment cost. The other method for regenerating an alkaline absorption liquid is implemented through direct electrolysis. However, this method has high electricity consumption at the present stage, and obtained by-products are difficult to control and use, so that this method is high in cost. How to implement CO₂ capture within a wide concentration range, and reduce the capture cost are main objectives in carbon dioxide capture and utilization fields at the present stage.

### SUMMARY

A main objective of the present disclosure is to provide a carbon dioxide capture method for coupled staged electrolysis/pyrolysis hydrogen production to solve the problems that an existing carbon capture method cannot implement CO₂ capture within a wide concentration range and has high capture cost.

To achieve the above objective, the present disclosure provides a carbon dioxide capture method for coupled staged electrolysis/pyrolysis hydrogen production. The carbon dioxide capture method for coupled staged electrolysis/pyrolysis hydrogen production includes the following operations: capturing carbon dioxide in a target component by using an alkaline solution and obtaining a carbonate-containing aqueous solution; enabling the carbonate-containing aqueous solution to be subjected to mild electrolysis, obtaining a hydroxide solution and hydrogen at a cathode, and obtaining a bicarbonate solution and a mixed gas of oxygen and carbon dioxide at an anode; capturing the carbon dioxide in the target component by taking the hydroxide solution as a capture agent in a capture step; enabling the mixed gas of the oxygen and the carbon dioxide to pass through a tail gas absorption tower to obtain pure oxygen; and pyrolyzing the bicarbonate solution to obtain pure carbon dioxide pyrolysis gas.

Further, a mild electrolysis process includes the following operations: feeding the carbonate-containing aqueous solution into an electrolysis tank, controlling a voltage and a current to perform electrolysis, obtaining the hydroxide solution and the hydrogen at the cathode, and obtaining the bicarbonate solution, and the mixed gas of the oxygen and the carbon dioxide at the anode.

Further, the voltage of the electrolysis tank is 1.5 to 3.5 V, a current density is 800 to 8000 A/m², the pH of the carbonate-containing aqueous solution is 10 to 13, and a concentration of a carbonate in the carbonate-containing aqueous solution is 1.2 to 4 mol/L.

Further, the voltage of the electrolysis tank is 2 to 3V, the current density is 1000 to 7000 A/m², the pH of the carbonate-containing aqueous solution is 11 to 12.5, and the concentration of the carbonate in the carbonate-containing aqueous solution is 1.5 to 3 mol/L.

Further, the mild electrolysis process includes the following operation: controlling the voltage of the electrolysis tank to obtain the mixed gas of the oxygen and the carbon dioxide at the anode of the electrolysis tank. Volume content of the carbon dioxide in the mixed gas of the oxygen and the carbon dioxide is 0 to 20%.

Further, the mild electrolysis process further includes the following operations: enabling the mixed gas of the oxygen and the carbon dioxide generated at the anode to enter a tail gas absorption tower, and recycling the carbon dioxide by using the alkaline solution to obtain the pure oxygen and generate a carbonate solution. The carbonate solution may recycle back to an inlet of the electrolysis tank.

Further, the carbon dioxide capture method for coupled staged electrolysis/pyrolysis hydrogen production further includes the following operations: performing first pressurizing on the carbonate-containing aqueous solution to obtain a pressurized working medium liquid; performing the mild electrolysis process on the pressurized working medium liquid, obtaining the hydroxide solution and the hydrogen at the cathode, and obtaining the bicarbonate solution, and the mixed gas of the oxygen and the carbon dioxide at the anode; taking the hydroxide solution after depressurization as the capture agent in the capture step to capture the carbon dioxide in the target component, and then performing a pyrolysis process on the bicarbonate solution to obtain the pure carbon dioxide pyrolysis gas. Preferably, the carbon dioxide capture method for coupled staged electrolysis/pyrolysis hydrogen production further includes the following operations: enabling the mixed gas of the oxygen and the carbon dioxide to enter the tail gas absorption tower, recycling the carbon dioxide in the mixed gas by using the alkaline solution to obtain the pure oxygen and generate the carbonate solution, and recycling the carbonate solution back to the inlet of the electrolysis tank.

Further, both the mild electrolysis process and the pyrolysis process are performed in a pressurized state, and a pressure in a pressurization process is the same as a storage or utilization pressure of the hydrogen, the oxygen, and the carbon dioxide downstream.

Further, the carbon dioxide capture method for coupled staged electrolysis/pyrolysis hydrogen production further includes the following operations: performing first pressurizing on the carbonate-containing aqueous solution to obtain the pressurized working medium liquid; performing the mild electrolysis process on the pressurized working medium liquid, obtaining the hydroxide solution and the hydrogen at the cathode, and obtaining the bicarbonate solution, and the mixed gas of the oxygen and the carbon dioxide at the anode; and pressurizing the bicarbonate solution for a second time, and then performing the pyrolysis process to obtain carbon dioxide pyrolysis gas. Preferably, the carbon dioxide capture method for coupled staged electrolysis/pyrolysis hydrogen production further includes the following operations: enabling the mixed gas of the oxygen and the carbon dioxide to enter the tail gas absorption tower, recycling the carbon dioxide in the mixed gas by using the alkaline solution to obtain the pure oxygen and generate the carbonate solution, and recycling the carbonate solution back to the inlet of the electrolysis tank.

Further, all of the hydrogen, the oxygen, and the carbon dioxide pyrolysis gas have a pressure, the hydrogen, the oxygen, and the carbon dioxide pyrolysis gas are not mixed with one another and are respectively fed into respective pressure containers for storage through different gas paths, or serve as industrial and agricultural raw materials for downstream use.

Further, a liquid product in the pyrolysis process is the carbonate solution. The carbon dioxide capture method for coupled staged electrolysis/pyrolysis hydrogen production further includes the following operation: recycling part or all of the carbonate solution as the alkaline solution.

Further, the pyrolysis process includes the following operations: feeding the bicarbonate solution into a pyrolysis tank for heating, releasing the pure carbon dioxide pyrolysis gas, and obtaining the carbonate solution.

Further, a concentration of the bicarbonate solution is 1.5 to 4.8 mol/L, and a pyrolysis temperature is 50 to 95° C. in the pyrolysis process.

By applying a technical solution of the present disclosure, through the above carbon dioxide capture method for coupled staged electrolysis/pyrolysis hydrogen production, the alkaline solution is recycled as an absorbent working medium liquid to absorb and release the carbon dioxide, which can not only capture high-concentration carbon dioxide, but also capture low-concentration carbon dioxide. A technology for capturing carbon dioxide within a wide concentration range may be provided. An alkaline absorption solution is regenerated in a staged electrolysis/pyrolysis manner. Mild electrolysis is performed by controlling the voltage and the current of the electrolysis tank, the hydroxide solution and the hydrogen may be obtained at the cathode of the electrolysis tank, and the bicarbonate solution and the mixed gas of the oxygen and the carbon dioxide may be obtained at the anode. The pure oxygen may be obtained after the mixed gas of the oxygen and the carbon dioxide passes through the tail gas absorption tower. The hydroxide solution after electrolysis returns to the absorption tower to capture the carbon dioxide in the target component. The bicarbonate solution after the electrolysis enters the pyrolysis tank, and the pure carbon dioxide can be obtained through pyrolysis. That is, three gas products may be respectively generated at different parts and stages without mixing and without additional separation equipment, and may be used as subsequent by-products for using respectively, which greatly reduces the cost for carbon capture and use.

### BRIEF DESCRIPTION OF THE DRAWINGS

Accompanying drawings which constitute a part of this disclosure are used to provide a further understanding of the present disclosure, and exemplary embodiments of the present disclosure and the description thereof are used to explain the present disclosure, but do not constitute improper limitations to the present disclosure. In the drawings:

FIG. 1 is a schematic structural diagram of a device used for a carbon dioxide capture method for coupled staged electrolysis/pyrolysis hydrogen production according to a preferred implementation of this disclosure.

The above drawings include the following reference signs:
1, flue gas/air; 2, de-carbonized flue gas/air; 3, atmospheric-pressure alkaline solution; 4, supplementing water; 5, carbon capture device; 6, atmospheric-pressure carbonate solution; 7, atmospheric-pressure/high-pressure carbonate solution; 8, liquid pump; 9, electrolysis tank; 10, atmospheric-pressure/high-pressure hydroxide solution; 11, atmospheric-pressure/high-pressure bicarbonate solution; 12, hydrogen; 13, mixed gas of oxygen and carbon dioxide; 14, oxygen; 15, absorption tower; 16, pyrolysis tank; 17, carbon dioxide pyrolysis gas; 18, pyrolyzed salt solution; and 19, cooling and de-pressurizing equipment.

### DETAILED DESCRIPTION OF THE EMBODIMENTS

It is to be noted that embodiments in this disclosure and features in the embodiment may be combined with each other without a conflict. The present disclosure will be described below with reference to the embodiments in detail.

As described in the Background, an existing carbon capture method cannot solve a problem about capturing carbon dioxide within a wide concentration range. To solve the above technical problem, this disclosure provides a carbon dioxide capture method for coupled staged electrolysis/pyrolysis hydrogen production. The carbon dioxide capture method for coupled staged electrolysis/pyrolysis hydrogen production includes the following operations: carbon dioxide in a target component is captured by using an alkaline solution and a carbonate-containing aqueous solution is obtained; the carbonate-containing aqueous solution is subjected to mild electrolysis, a hydroxide solution and hydrogen are obtained at a cathode, and a bicarbonate solution and a mixed gas of oxygen and carbon dioxide are obtained at an anode; the carbon dioxide in the target component is captured by taking the hydroxide solution as a capture agent; the mixed gas of the oxygen and the carbon dioxide passes through a tail gas absorption tower to absorb the carbon dioxide to obtain pure oxygen; and the bicarbonate solution is pyrolyzed to obtain pure carbon dioxide pyrolysis gas.

Through the above carbon dioxide capture method for coupled staged electrolysis/pyrolysis hydrogen production, the alkaline solution is recycled as an absorbent working medium liquid to absorb and release the carbon dioxide, which can not only capture high-concentration carbon dioxide, but also capture low-concentration carbon dioxide. A technology for capturing carbon dioxide within a wide concentration range may be provided. An alkaline absorption solution is regenerated in a staged electrolysis/pyrolysis manner. Mild electrolysis is performed by controlling a voltage and a current of an electrolysis tank, the hydroxide solution and the hydrogen can be obtained at the cathode of the electrolysis tank, the bicarbonate solution, and the mixed gas of the oxygen and the carbon dioxide can be obtained at the anode. The pure oxygen may be obtained after the mixed gas of the oxygen and the carbon dioxide passes through the tail gas absorption tower. The hydroxide solution after the electrolysis returns to the absorption tower to capture the carbon dioxide in the target component. The bicarbonate solution after the electrolysis enters a pyrolysis tank, and pure carbon dioxide can be obtained through pyrolysis. That is, three gas products may be respectively generated at different parts and stages without mixing and without additional separation equipment, and may be used as subsequent by-products for using respectively, which greatly reduces the cost for carbon capture and use.

In a preferred embodiment, the mild electrolysis process includes the following operations: the carbonate-containing aqueous solution is fed into the electrolysis tank, the voltage is controlled to perform electrolysis, the hydroxide solution and the hydrogen are obtained at the cathode, and the bicarbonate solution and the mixed gas of the oxygen and the carbon dioxide are obtained at the anode. Through the mild electrolysis process, the alkaline absorption solution can be primarily regenerated, and the hydrogen can be obtained at the cathode of the electrolysis tank, and the mixed gas of the oxygen and the carbon dioxide can be obtained at the anode.

In a preferred embodiment, the voltage of the electrolysis tank is 1.5 to 3.5 V, a current density is 800 to 8000 A/m², the pH of the carbonate-containing aqueous solution is 10 to 13, and a concentration of a carbonate in the carbonate-containing aqueous solution is 1.2 to 4 mol/L. The voltage of the electrolysis tank, the current density, and the concentration of the carbonate in the carbonate-containing aqueous solution include, but are not limited to, the above ranges. Limiting the three parameters within the above ranges is beneficial to further improving the yield of the hydrogen and the oxygen in the mild electrolysis process and the electrolytic efficiency. More preferably, the voltage of the electrolysis tank is 2 to 3V, the current density is 1000 to 7000 A/m², the pH of the carbonate-containing aqueous solution is 11 to 12.5, and the concentration of the carbonate in the carbonate-containing aqueous solution is 1.5 to 3 mol/L.

In a preferred embodiment, the mild electrolysis process includes the following operation: the voltage of the electrolysis tank is controlled to obtain the mixed gas of the oxygen and the carbon dioxide at the anode of the electrolysis tank. Volume content of the carbon dioxide in the mixed gas of the oxygen and the carbon dioxide is 0 to 20%. More preferably, the above mild electrolysis process further includes the following operations: the mixed gas of the oxygen and the carbon dioxide generated at the anode enters the tail gas absorption tower, the carbon dioxide is recycled by using the alkaline solution to obtain the pure oxygen and generate a carbonate solution, and the carbonate solution is recycled back to an inlet of the electrolysis tank.

In a preferred embodiment, the carbon dioxide capture method for coupled staged electrolysis/pyrolysis hydrogen production further includes: the carbonate-containing aqueous solution is pressurized for a first time to obtain a pressurized working medium liquid; the mild electrolysis process is performed on the pressurized working medium liquid, the hydroxide solution and the hydrogen are obtained at the cathode, and the bicarbonate solution, and the mixed gas of the oxygen and the carbon dioxide are obtained at the anode; the hydroxide solution after depressurization is taken as a capture agent in a capture step to capture the carbon dioxide in the target component, and a pyrolysis process is performed on the bicarbonate solution to obtain the pure carbon dioxide pyrolysis gas. The working medium liquid is pressurized first, and then staged electrolysis/pyrolysis is performed to regenerate the alkaline absorption liquid, and meanwhile, an obtained gas product may be in a high-pressure state. The gas may be directly stored or supplied for downstream use without being re-compressed. Power consumption for pressurizing a liquid is much lower than that for pressurizing a gas, so the power consumption for capturing, utilizing, and storing the carbon dioxide can be greatly reduced by the above carbon capture method. Preferably, the carbon dioxide capture method for coupled staged electrolysis/pyrolysis hydrogen production further includes: the mixed gas of the oxygen and the carbon dioxide enters the tail gas absorption tower, the carbon dioxide in the mixed gas is recycled by using the alkaline solution to obtain the pure oxygen and generate the carbonate solution, and the carbonate solution is recycled back to the inlet of the electrolysis tank. To further reduce the energy consumption, more preferably, both the mild electrolysis process and the pyrolysis process are performed in a pressurized state, and a pressure in a pressurization process is the same as a storage or utilization pressure of the hydrogen, the oxygen, and the carbon dioxide downstream.

In an another preferred embodiment, the carbon dioxide capture method for coupled staged electrolysis/pyrolysis hydrogen production further includes the following operations: the carbonate-containing aqueous solution is pressurized for the first time to obtain the pressurized working medium liquid; the mild electrolysis process is performed on the pressurized working medium liquid, the hydroxide solution and the hydrogen are obtained at the cathode, the bicarbonate solution, and the mixed gas of the oxygen and the carbon dioxide are obtained at the anode; the bicarbonate solution is pressurized for the second time, and then a pyrolysis process is performed to obtain the carbon dioxide pyrolysis gas. Pressurizing treatment is performed in each of the mild electrolysis process and the pyrolysis process, so that hydrogen, the oxygen, and the carbon dioxide at different pressures may be obtained. More preferably, the above carbon dioxide capture method for coupled staged electrolysis/pyrolysis hydrogen production further includes the following operations: the mixed gas of the oxygen and the carbon dioxide enters the tail gas absorption tower, the carbon dioxide in the mixed gas is recycled by using the alkaline solution to obtain the pure oxygen and generate the carbonate solution, and the carbonate solution is recycled back to the inlet of the electrolysis tank. To improve the utilization rate of the above three gases, preferably, all of the hydrogen, the oxygen, and the carbon dioxide pyrolysis gas have a pressure, the hydrogen, the oxygen, and the carbon dioxide pyrolysis gas are not mixed with one another and are respectively fed into respective pressure containers for storage through different gas paths, or serve as industrial and agricultural raw materials for downstream use.

A liquid product in the pyrolysis process is the carbonate solution. To improve the sustainability and the environmental friendliness of the overall process, preferably, the carbon dioxide capture method for above coupled staged electrolysis/pyrolysis hydrogen production further includes the following operation: part or all of the carbonate solution is recycled as the alkaline solution.

In a preferred embodiment, the pyrolysis process includes: the bicarbonate solution is fed into the pyrolysis tank and is heated, the pure carbon dioxide pyrolysis gas is released, and the carbonate solution is obtained.

To further improve the yield of the carbon dioxide pyrolysis gas in the pyrolysis process, parameters of the pyrolysis process may be optimized. In a preferred embodiment, a concentration of the bicarbonate solution is 1.5 to 4.8 mol/L, and a pyrolysis temperature is 50 to 95° C. in the pyrolysis process. The concentration of the bicarbonate solution and the temperature in the pyrolysis process include, but are not limited to, the above ranges. Limiting the three parameters within the above ranges is beneficial to further improving the yield of the carbon dioxide pyrolysis gas.

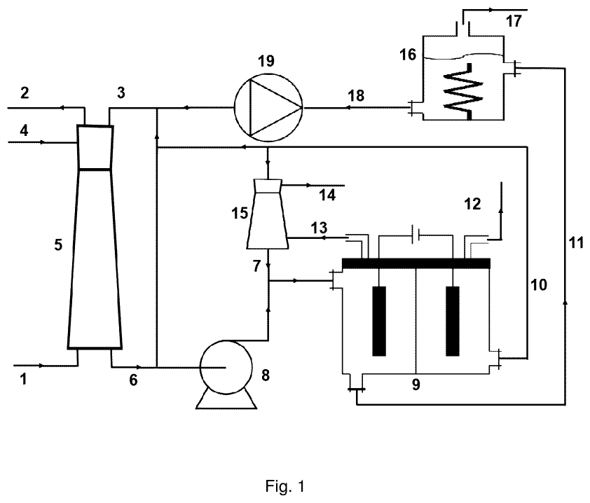

A process flow of a preferred carbon dioxide capture method for coupled staged electrolysis/pyrolysis hydrogen production provided in this disclosure is as shown in FIG. 1, which specifically includes the following operations.

A capture process of the carbon dioxide includes the following operations: carbon dioxide in a target component (flue gas/air 1) is captured by an atmospheric-pressure alkaline solution 3 in a carbon capture device 5 to obtain an atmospheric-pressure carbonate solution 6 and de-carbonized flue gas/air 2, and meanwhile, a suitable amount of supplementing water 4 may be added as required in a capture process.

The mild electrolysis process includes: the atmospheric-pressure carbonate solution 6 is fed into an electrolysis tank 9 through a liquid pump 8; the voltage is controlled to perform electrolysis; an atmospheric-pressure/high-pressure hydroxide solution 10 and hydrogen 12 are obtained at a cathode; and an atmospheric-pressure/high-pressure bicarbonate solution 11 and a mixed gas 13 of oxygen and carbon dioxide are obtained at an anode (the atmospheric-pressure/high-pressure hydroxide solution refers to a hydroxide solution at an atmospheric pressure or a high pressure).

The mixed gas 13 of the oxygen and the carbon dioxide enters an absorption tower 15, and the carbon dioxide is recycled by using the atmospheric-pressure/high-pressure hydroxide solution 10 to obtain pure oxygen 14. Meanwhile, a generated atmospheric-pressure/high-pressure carbonate solution 7 may be recycled back to an inlet of the electrolysis tank 9.

The atmospheric-pressure/high-pressure bicarbonate solution 11 enters a pyrolysis device 16 to be subjected to a pyrolysis process to obtain pure carbon dioxide pyrolysis gas 17. A pyrolyzed salt solution 18 serves as a capture agent of the carbon capture device 5 after being depressurized by a cooling and de-pressurizing equipment 19.

This disclosure is further described below in detail in combination with specific embodiments. These embodiments cannot be understood as limiting a scope of protection required by this disclosure.

### Embodiment 1

A carbon dioxide capture method for coupled staged electrolysis/pyrolysis hydrogen production was performed by using the device shown in FIG. 1, which specifically included the following steps.

A carbon dioxide capture process included the following operations: carbon dioxide in a target component was captured by using an alkaline solution to obtain a carbonate-containing aqueous solution, where the target component was air, a volume fraction of the carbon dioxide was 400 ppm, the alkaline solution was 1.38 mol/L NaOH aqueous solution, the carbonate-containing aqueous solution was 1.51 mol/L Na₂CO₃ solution, and the pH was 13.8.

A mild electrolysis process included the following operations: the Na₂CO₃ solution was fed into an electrolysis tank, a voltage was controlled to perform electrolysis, NaOH solution and hydrogen are obtained at a cathode, and the NaHCO₃ solution, oxygen, and a mixture of carbon dioxide with a dry basis volume fraction of approximately 33.5% were obtained at an anode. The voltage of the electrolysis tank was 2.6 V, a current density was 1050 A/m², the pH of the carbonate-containing aqueous solution was 8.61, a concentration of the Na₂CO₃ in the Na₂CO₃ solution was 0.051 mol/L, a concentration of NaHCO₃ solution was 1.53 mol/L, and a dry basis yield of the mixed gas of the oxygen and the carbon dioxide was 29.6 kg/h. The mixed gas entered a small absorption tower device, the carbon dioxide was recycled by using the alkaline solution to generate a carbonate solution, and the carbonate solution might recycle back to an inlet of the electrolysis tank. The NaOH solution returned to the absorption tower to capture the carbon dioxide in the target component, and the NaHCO₃ solution was subjected to a pyrolysis process to obtain pure carbon dioxide pyrolysis gas. The three gases were respectively fed into respective pressure containers for storage through different gas paths, or served as industrial and agricultural raw materials for downstream use.

The pyrolysis process included the following operations: the above NaHCO₃ solution was fed into a pyrolysis tank for heating, the carbon dioxide was released, and a mixed salt solution of the Na₂CO₃ and a small amount of the NaHCO₃ was obtained. In the pyrolysis process, a concentration of the NaHCO₃ was 1.15 mol/L, and a pyrolysis temperature was 95° C. To improve the sustainability and the environmental friendliness of the overall process, part or all of the mixed salt solution of the Na₂CO₃ and the small amount of the NaHCO₃ was taken as a cyclic alkaline solution.

In this embodiment, according to the conditions, it could be obtained that the carbon capture amount was 6.15 kg/s, and main resource consumption and output per unit time during an operation process were shown in Table 1.

TABLE 1
Main resource consumption and output per unit time

| | | Consumption | | |
|---|---|---|---|---|
| | | quantity/ | Unit | |
| Consumption | | production | price | Particular |
| and output | Item | quantity | (yuan) | charge |
| Consumption | Steam (kg) | 45.1 | 0.12 | 5.41 |
| | Electricity | 380.9 | 0.15 | 57.14 |
| | consumption (kW · h) | | | |
| | Consumption of | 161.2 | 0.009 | 1.45 |
| | supplementing water | | | |
| | (kg) | | | |
| Output | H₂ (kg) | 1.67 | 40 | 66.98 |

It can be learned from the data in the above table that the capture cost of the carbon dioxide is about −484.1 yuan/ton, that is, the net profit per ton of the captured carbon dioxide is 484.1 yuan.

It can be seen from the above description that the above embodiment of the present disclosure achieves the following technical effects: through the above carbon dioxide capture method for coupled staged electrolysis/pyrolysis hydrogen production, the alkaline solution is recycled as an absorbent working medium liquid to absorb and release the carbon dioxide, which can not only capture high-concentration carbon dioxide, but also capture low-concentration carbon dioxide. A technology for capturing carbon dioxide within a wide concentration range may be provided. An alkaline absorption solution is regenerated in a staged electrolysis/pyrolysis manner. Mild electrolysis is performed by controlling the voltage and the current of the electrolysis tank, the hydroxide solution and the hydrogen can be obtained at the cathode of the electrolysis tank, the bicarbonate solution, and the mixed gas of the oxygen and the carbon dioxide can be obtained at the anode. Pure oxygen can be obtained after the mixed gas of the oxygen and the carbon dioxide passes through the tail gas absorption tower. The hydroxide solution after the electrolysis returns the absorption tower to capture the carbon dioxide in the target component. The bicarbonate solution after the electrolysis enters a pyrolysis tank, and pure carbon dioxide can be obtained through pyrolysis. That is, three gas products may be generated at different parts and stages without mixing and without additional separation equipment, and may be used as subsequent by-products for using respectively, which greatly reduces the cost for carbon capture and use.

It is to be noted that the terms “first”, “second”, and the like in the specification and claims of this disclosure are used to distinguish similar objects, and do not need to describe a specific sequence or a precedence order. It is to be understood that the terms used in such a way may be exchanged under appropriate conditions, so that implementations of this disclosure described here can be implemented in, for example, a sequence other than sequences graphically described here.

The above are only preferred embodiments of the present disclosure and are not intended to limit the present disclosure. For those skilled in the art, the present disclosure may have various modifications and changes. Any modifications, equivalent replacements, improvements, and the like made within the spirit and principle of the present disclosure shall fall within the scope of protection of the present disclosure.

1. A carbon dioxide capture method for coupled staged electrolysis/pyrolysis hydrogen production, the carbon dioxide capture method for coupled staged electrolysis/pyrolysis hydrogen production comprising:
capturing carbon dioxide in a target component by using an alkaline solution, and obtaining a carbonate-containing aqueous solution;
enabling the carbonate-containing aqueous solution to be subjected to mild electrolysis, obtaining a hydroxide solution and hydrogen at a cathode, and obtaining a bicarbonate solution, and a mixed gas of oxygen and carbon dioxide at an anode;
absorbing the carbon dioxide in the target component by using the hydroxide solution as a capture agent in a capture step;
enabling the mixed gas of the oxygen and the carbon dioxide to pass through a tail gas absorption tower to absorb the carbon dioxide to obtain pure oxygen;
pyrolyzing the bicarbonate solution to obtain pure carbon dioxide pyrolysis gas.

2. The carbon dioxide capture method for coupled staged electrolysis/pyrolysis hydrogen production according to claim 1, wherein a mild electrolysis process comprises: feeding the carbonate-containing aqueous solution into an electrolysis tank, controlling a voltage and a current to perform electrolysis, obtaining the hydroxide solution and the hydrogen at the cathode, and obtaining the bicarbonate solution, and the mixed gas of the oxygen and the carbon dioxide at the anode.

3. The carbon dioxide capture method for coupled staged electrolysis/pyrolysis hydrogen production according to claim 2, wherein the voltage of the electrolysis tank is 1.5 to 3.5 V, a current density is 800 to 8000 A/m², the pH of the carbonate-containing aqueous solution is 10 to 13, and a concentration of a carbonate in the carbonate-containing aqueous solution is 1.2 to 4 mol/L.

4. The carbon dioxide capture method for coupled staged electrolysis/pyrolysis hydrogen production according to claim 3, wherein the voltage of the electrolysis tank is 2 to 3V, the current density is 1000 to 7000 A/m², the pH of the carbonate-containing aqueous solution is 11 to 12.5, and the concentration of the carbonate in the carbonate-containing aqueous solution is 1.5 to 3 mol/L.

5. The carbon dioxide capture method for coupled staged electrolysis/pyrolysis hydrogen production according to claim 4, wherein the mild electrolysis process comprises: controlling the voltage of the electrolysis tank to obtain the mixed gas of the oxygen and the carbon dioxide at the anode of the electrolysis tank, wherein volume content of the carbon dioxide in the mixed gas of the oxygen and the carbon dioxide is 0 to 20%.

6. The carbon dioxide capture method for coupled staged electrolysis/pyrolysis hydrogen production according to claim 5, wherein the mild electrolysis process further comprises: enabling the mixed gas of the oxygen and the carbon dioxide generated at the anode to enter the tail gas absorption tower, recycling the carbon dioxide by using the alkaline solution to obtain the pure oxygen and generate a carbonate solution, and recycling the carbonate solution back to an inlet of the electrolysis tank.

7. The carbon dioxide capture method for coupled staged electrolysis/pyrolysis hydrogen production according to claim 5, the carbon dioxide capture method for coupled staged electrolysis/pyrolysis hydrogen production further comprising:
performing first pressurizing on the carbonate-containing aqueous solution to obtain a pressurized working medium liquid;
performing the mild electrolysis process on the pressurized working medium liquid, obtaining the hydroxide solution and the hydrogen at the cathode, and obtaining the bicarbonate solution, and the mixed gas of the oxygen and the carbon dioxide at the anode;
taking the hydroxide solution after depressurization as the capture agent in the capture step to capture the carbon dioxide in the target component, and then performing a pyrolysis process on the bicarbonate solution to obtain the pure carbon dioxide pyrolysis gas;
preferably, the carbon dioxide capture method for coupled staged electrolysis/pyrolysis hydrogen production further comprising: enabling the mixed gas of the oxygen and the carbon dioxide to enter the tail gas absorption tower, recycling the carbon dioxide in the mixed gas by using the alkaline solution to obtain the pure oxygen and generate the carbonate solution, and recycling the carbonate solution back to the inlet of the electrolysis tank.

8. The carbon dioxide capture method for coupled staged electrolysis/pyrolysis hydrogen production according to claim 7, wherein both the mild electrolysis process and the pyrolysis process are performed in a pressurized state, and a pressure in a pressurization process is the same as a storage or utilization pressure of the hydrogen, the oxygen, and the carbon dioxide downstream.

9. The carbon dioxide capture method for coupled staged electrolysis/pyrolysis hydrogen production according to claim 5, the carbon dioxide capture method for coupled staged electrolysis/pyrolysis hydrogen production further comprising:
performing first pressurizing on the carbonate-containing aqueous solution to obtain a pressurized working medium liquid;
performing the mild electrolysis process on the pressurized working medium liquid, obtaining the hydroxide solution and the hydrogen at the cathode, and obtaining the bicarbonate solution, and the mixed gas of the oxygen and the carbon dioxide at the anode;
performing second pressurizing on the bicarbonate solution, and then performing the pyrolysis process to obtain carbon dioxide pyrolysis gas;
preferably, the carbon dioxide capture method for coupled staged electrolysis/pyrolysis hydrogen production further comprising: enabling the mixed gas of the oxygen and the carbon dioxide to enter the tail gas absorption tower, recycling the carbon dioxide in the mixed gas by using the alkaline solution to obtain the pure oxygen and generate the carbonate solution, and recycling the carbonate solution back to the inlet of the electrolysis tank.

10. The carbon dioxide capture method for coupled staged electrolysis/pyrolysis hydrogen production according to claim 9, wherein all of the hydrogen, the oxygen, and the carbon dioxide pyrolysis gas have a pressure, the hydrogen, the oxygen, and the carbon dioxide pyrolysis gas are not mixed with one another and are respectively fed into respective pressure containers for storage through different gas paths, or serve as industrial and agricultural raw materials for downstream use.

11. The carbon dioxide capture method for coupled staged electrolysis/pyrolysis hydrogen production according to claim 1, wherein a liquid product in the pyrolysis process is the carbonate solution; and the carbon dioxide capture method for coupled staged electrolysis/pyrolysis hydrogen production further comprises: recycling part or all of the carbonate solution as the alkaline solution.

12. The carbon dioxide capture method for coupled staged electrolysis/pyrolysis hydrogen production according to claim 1, wherein the pyrolysis process comprises: feeding the bicarbonate solution into a pyrolysis tank for heating, and releasing the pure carbon dioxide pyrolysis gas, and obtaining the carbonate solution.

13. The carbon dioxide capture method for coupled staged electrolysis/pyrolysis hydrogen production according to claim 12, wherein a concentration of the bicarbonate solution is 1.5 to 4.8 mol/L, and a pyrolysis temperature is 50 to 95° C. in a pyrolysis process.

14. The carbon dioxide capture method for coupled staged electrolysis/pyrolysis hydrogen production according to claim 7, the carbon dioxide capture method for coupled staged electrolysis/pyrolysis hydrogen production further comprising: enabling the mixed gas of the oxygen and the carbon dioxide to enter the tail gas absorption tower, recycling the carbon dioxide in the mixed gas by using the alkaline solution to obtain the pure oxygen and generate the carbonate solution, and recycling the carbonate solution back to the inlet of the electrolysis tank.

15. The carbon dioxide capture method for coupled staged electrolysis/pyrolysis hydrogen production according to claim 9, the carbon dioxide capture method for coupled staged electrolysis/pyrolysis hydrogen production further comprising: enabling the mixed gas of the oxygen and the carbon dioxide to enter the tail gas absorption tower, recycling the carbon dioxide in the mixed gas by using the alkaline solution to obtain the pure oxygen and generate the carbonate solution, and recycling the carbonate solution back to the inlet of the electrolysis tank.
